(19) United States
(12) Patent Application Publication
(10) Pub. No.: US 2026/0111353 A1
(43) Pub. Date: Apr. 23, 2026

(54) PUBLISH-SUBSCRIBE MECHANISM FOR PARALLEL MEMORY SYSTEM

(71) Applicant: NVIDIA Corp., Santa Clara, CA (US)

(72) Inventors: Benjamin Klenk, San Jose, CA (US); Nicolai Oswald, San Jose, CA (US); Ankit More, San Mateo, CA (US); Dennis Charles Abts, Deerfield, IL (US); Larry Robert Dennison, Mendon, MA (US)

(73) Assignee: NVIDIA Corp., Santa Clara, CA (US)

(21) Appl. No.: 19/305,333

(22) Filed: Aug. 20, 2025

Related U.S. Application Data
(60) Provisional application No. 63/708,534, filed on Oct. 17, 2024.

(51) Int. Cl. G06F 12/02

(52) U.S. Cl. CPC G06F 12/023; G06F 2212/10

(57) ABSTRACT

Producer/consumer mechanisms whereby the consumer issues a request to set up a monitor in a machine memory system. Incoming updates by a single or multiple producer(s) are recorded by the monitors and when an update to a subscribed location or region is observed, the memory system either records and counts the updates, or directly reflects the updates and forwards them to a single or multiple subscribed consumer(s).

### CROSS-REFERENCE TO RELATED APPLICATIONS

This application claims priority and benefit under 35 U.S.C. 119(e) to U.S. application Ser. No. 63/708,534, “Publish-Subscribe Mechanism for Parallel Memory System”, filed on Oct. 17, 2024, the contents of which are incorporated herein by reference in their entirety.

### BACKGROUND

Synchronization is an important aspect of any parallel-execution workload especially in the context of producer-consumer patterns. In multi-threaded execution environments, worker units (e.g., individual threads or groups of threads) signal other worker units when they have completed a task, thereby enabling other waiting tasks to be initiated. In systems implemented a shared-memory runtime environment, this signaling may be implemented by having resource consumer workers poll a memory location that producer workers update when their work is complete and visible.

In these implementations, consumers may frequently check whether or not the shared memory location has been updated, introducing additional latency and energy consumption overhead. This overhead is amplified when multiple consumers wait on updates to the same shared memory location, as serialization contention for reading the location may incur additional latency.

The Cray XMT machine implements extended memory semantics that included empty/full bits for every 64b word. A ‘read-if-full’ instruction enables the memory to keep the request until a ‘write-if-empty’ arrived for the same location.

The x86 instruction set includes instructions applied to an address range. When these instructions are executed, storing updates to the address range triggers monitoring hardware.

The ARM instruction set includes a ‘stash mechanism’ that improves communication latency in common producer-consumer communication patterns. A consumer sends a prefetch-with-intent-to-read request (PRFM IR) to a ‘home node’ to register as a target for data written by a producer. In the event of a producer write stash (STSH) request, the home node queries the registered consumers as to whether or not they are ready to accept the written data. If a consumer is ready to read the data (e.g. cache line is in a stable state) it acknowledges, confirming its intent to read to the data. Once the home node receives the acknowledgment of a consumer that it is ready to accept the data, it forwards the data to the consumer. Therefore, a subsequent load access by the consumer for the data will hit its local cache.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a consumer/producer interaction in accordance with one embodiment.

FIG. 2 depicts a consumer/producer interaction in accordance with another embodiment.

FIG. 3 depicts a consumer/producer interaction in accordance with another embodiment.

FIG. 4A-FIG. 4B depict a computing system in accordance with one embodiment.

FIG. 5 depicts an example implementation of tags for use with monitored addresses and address ranges.

FIG. 6A-FIG. 6B depict a consumer/producer interaction in accordance with another embodiment.

FIG. 7 depicts a consumer/producer interaction in accordance with an embodiment utilizing counted writes.

FIG. 8 depicts an example of deferred update notification.

FIG. 9 depicts a consumer/producer interaction in accordance with another embodiment.

FIG. 10A depicts a consumer/producer interaction in accordance with another embodiment.

FIG. 10B depicts a consumer/producer interaction in accordance with another embodiment.

FIG. 11A-FIG. 11B depict consumer/producer interactions in accordance with different embodiments.

FIG. 12 depicts a producer/consumer ring buffer implementation in one embodiment

FIG. 13 depicts a parallel processing unit in accordance with one embodiment.

FIG. 14 depicts a general processing cluster in accordance with one embodiment.

FIG. 15 depicts a memory partition unit in accordance with one embodiment.

FIG. 16 depicts a streaming multiprocessor in accordance with one embodiment.

FIG. 17 depicts a processing system in accordance with one embodiment.

FIG. 18 depicts an exemplary processing system in accordance with another embodiment.

### DETAILED DESCRIPTION

Disclosed herein are mechanisms to enable consumer units in a parallel processing computer system to subscribe to a memory location or region. With the disclosed mechanisms, a consumer issues a single request to establish a monitor in the memory system. Incoming updates by a single or multiple producer units are recorded by the monitors. When an update to a subscribed location or region is detected, the memory system either (1) records and counts the update, or (2) directly reflects the update to the subscribed consumer(s).

The following terms may be used herein in conjunction with the disclosed embodiments.

“Consumer process” refers to a process that reads data generated in memory by a producer process.

“Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter).

“Producer process” refers to a process that strores/writes values to memory.

“Shared memory” refers to a memory that is addressable by both a producer process and a consumer process.

“Subscription” refers to settings that establish a monitor for changes to the contents one or more memory locations.

“Tag” refers to identifiers associated with a memory location or range of memory locations.

The disclosed mechanisms may utilize two memories to implement subscriptions. The first is the local memory of the consumer, e.g., a thread-local virtual memory space. The second is a memory where the producer writes/store the data that the consumer is subscribing to. The producer is unaware of the local allocation of the consumer and only interacts with the shared memory where it writes the data to. The consumer subscribes to an address in the second memory, which is shared with the producer, and when the producer writes to the subscribe address, the monitor logic can forward counts or other notifications for the available data to the local allocation of the consumer. The memory manager is aware of the local allocation via the subscription request from the consumer. The memory manager is also aware of the shared memory area via the producer's write instructions, so that when the monitor forwards the data to the consumer, may embed the global address in the notification. When the consumer receives the notification, can copy the data into its local address space (if desired).

To subscribe to a memory location or region, a consumer may identify at least one ‘local’ memory location for use as a counter. The memory system periodically sends counter updates to these local addresses. The consumer may also provide the system with a memory location for the updated data, which may then be forwarded directly into the provided location.

A local address is an address in the address space of the consumer, e.g., in the address space of an application, thread, kernel, driver, operating system, etc. In general, the address provided for a subscription need not be local. In some embodiments, the provided address may be the address in a memory of a different processor, chip, board, or device than the one hosting the consumer.

The disclosed mechanisms enable consumers to subscribe to a memory location or address range, and apply counters to obviate the use of ‘memory fences’ for synchronization between producers and consumers.

Herein, the term ‘subscription’ refers to a request from a data processor (e.g., a GPU or CPU or controller) to a memory system to establish a monitor. A monitor is logic configured to match memory updates with a configured target address or address range. In response to a match, a configured action is triggered. One example of an action is to increment a counter. Another example of an action is to communicate the the update to the target address to one or more subscribers.

In one embodiment, a computer system comprises multiple GPUs, and each L2 cache slice utilized by the GPUs implements its own monitors.

An L2 cache slice is a segment of the level 2 (L2) cache in a computer system. In some multi-core processors, the L2 cache is divided into multiple slices, with each slice being associated with a specific core or set of cores. This distribution of the L2 cache helps to improve memory access times and efficiency, as data can be quickly retrieved from the slice closest (in either a physical or latency sense) to a requesting core.

Each L2 slice comprises a portion of the total L2 cache capacity. Data mapping across slices may be managed using mechanisms such as hash functions, helping to ensure that requests are evenly distributed and low latency is maintained. Cache coherence protocols may be implemented to help ensure that the L2 slices maintain consistency across the processor's memory hierarchy.

Address range subscription requests may be communicated (e.g., via broadcast) to the monitors in all available L2 slices. Established monitors may remain active until explicitly removed, until a timeout occurs, or automatically after tracking a configured number of updates. Each subscription may comprise a local memory location where updates are written by the memory system upon detection. The local address may specify a single location for unitary (e.g., a single 32 bit value) address subscriptions, or a larger memory space for subscriptions to ranges of addresses.

In one embodiment, subscriptions may be associated with tag values. For example, in response to a memory allocation operation instituted via an application program interface (API) function call, the memory system page tables may be updated to include a tag that indexes the monitors. When a store (write) request is translated into a physical address, the tag is added to the request. Upon reaching the L2 cache, the monitor applies the tag to identify which subscription the store request belongs to. In different embodiments, tags may be assigned to addresses in the memory system, in a device driver (e.g., that implements memory allocation), or supplied as an operand in subscription or publish commands.

Monitors may be managed as finite system resources, such that the system falls back to using traditional synchronization mechanisms when available monitors are exhausted. Another approach to managing monitors is to offload monitor entries into allocable (more generally available) memory.

Counters used to track data writes/stores may also be a finite resource. In one embodiment, a credit system may be implemented to manage counter resources. For example, assume a memory system with a count limit of 8. A producer writing more than 8 times before any of the data is consumed will cause a counter overflow. The memory system may be configured to provide write/store credits to producers, e.g., each time they execute a store. publish instruction. The producer initially receives 8 credits and performs 8 writes to the subscribed address range. If a consumer consumes three of the data items, the count associated with the subscription may be decremented by three, and the memory system notifies the producer and provides 3 more write credits back.

A Bloom filter is a space-efficient probabilistic data structure used to test whether an element is a member of a set. It is particularly useful for applications where the amount of data is large, and memory efficiency is critical. A Bloom filter typically comprises a fixed-size array of bits, all initially set to 0, and a set of mutually-independent hash functions that map inputs to a range of bit positions in the array. When adding an element to the Bloom filter, each hash function computes a position, and the corresponding bits in the bit array are set to 1. To query the Bloom filter, the same set of hash functions determines which bits to check. If any bit at those positions is 0, the element is definitely not in the set. If all bits are 1, the element might be in the set, indicating a possible false positive.

To determine whether an observed memory update is tracked by a monitor with low latency, a bloom filter may be implemented to identify if a given update is monitored, and if so, the monitor may traverse its entries, including any that were offloaded into allocable memory. This mechanism has the benefit of being asynchronous with memory updates, but may reduce memory system performance in high resource utilization scenarios.

Monitored address ranges may be limited to the memory page size, unless tags are used as described above. A subscription comprising a virtual address requires an address translation before it reaches the destination memory (e.g., the L2) where the monitors track physical addresses. Subscribed addresses or ranges may not be aliased.

In one embodiment, a monitor's lifetime is limited to the lifetime of the creating domain, e.g., to the lifetime of a workload kernel. In another embodiment, system software (e.g., the operating system) may correlate monitors with the memory allocations they track (e.g. malloc ranges). In these embodiments, once an allocation is freed, the system software may free the corresponding monitor resources.

Requests, or responses to requests, may take the form of packets. Upon subscription to an address range with some local memory allocated, a data processor may wait for the memory system to forward updates to the address range. Once updates are forwarded, the processor may count how many updates were received. A count that matches a configured number of updates indicates to the processor that all expected update data has been received, and that the data in the address range may be consumed (applied somehow).

The second place where counting may take place is in the memory system itself. A subscriber may configure a monitor to count updates and communicate the count to the subscriber. The subscriber configures the monitor with a local memory location for writing the count.

The cache memory system of some data processors, such as GPU's, may be distributed. This may result in updates from producers being placed in different cache slices. Each slice may maintain its own count and communicate the count to a single memory location residing in the subscriber's local memory. In one embodiment for GPU-based systems, the local counter may be integrated into a streaming multiprocessor's synchronization unit for use in convergence barriers.

Significant bus bandwidth and processing overhead may be incurred if a counter update is generated to subscribers every time an update is observed by a monitor. Coalescing mechanisms may be implemented to reduce the number of such updates. One such mechanisms is to configure a static time window during which updates are coalesced. However, this mechanism may increase performance latency. Another coalescing mechanism involves monitoring a rate at which an update counter is incremented over a configured interval of time. If the rate starts to decrease, the counter updates coalesced in the static time window are communicated to subscribers. Communication of the updates may be delayed (but no further than the end of the window) while the rate remains high.

The disclosed mechanisms comprise an instruction herein referred to as LDSUB.MONITOR. This instruction instantiates an address monitor in the memory system for a single address location, for example a synchronization flag stored at a particular memory address. An operand of the instruction specifies a memory location local to the invoking consumer process where updates to the monitored address will be stored.

### LDSUB.MONITOR

### Operands

a. Global address (address to monitor in the L2)
b. Local address (address in local shared memory)
c. [optional] Specific value to detect when monitoring the global address

### Options

a. Persistent monitor: the monitor resource is not freed upon receiving updates from the producer
b. Observed flag value: the update is only sent to the subscribers once the flag is set to a given value. This requires the L2 to query the flag value any time an atomic read-modify-write (RMW) is observed.
c. Reuse count: a number of updates to receive before freeing the monitor resource

### Returns: Updated Value at Global Address Location (e.g., Read From L2 Cache)

The mechanism initiated by LDSUB.MONITOR may operate in different scenarios. In one scenario, the subscription is initiated before an update to the subscribed address by the producer. In this scenario the a new monitor is instantiated for the target address (e.g., by an L2 cache slice controller). This may involve the transmission of only a single message from the consumer to the monitor logic. Upon receiving an update to the monitored address from the producer, the monitor will forward the update to the subscribed consumer(s) and either keep the monitor active, or free it. An optional ‘reuse’ count can be implemented, to automatically delete an entry after n updates have been observed. This approach may be useful for epoch-based protocols, where producers can increment epochs and consumers are automatically kept up to date on the current epoch.

In one embodiment, the consumer may explicitly unsubscribe from the monitor upon receiving an update or a certain number of updates, or a particular updated value.

A second scenario involves an update received to an address before the monitor on that address is instantiated (e.g., after the LDSUB.MONITOR instruction is executed but before the corresponding monitor reaches/is instantiated in the L2 cache). Simply implementing the monitor upon receiving the subscription will result in loss of the update that already occurred.

One mechanism for dealing with this second scenario is for a newly established monitor to read the current value at the monitored address and return it, regardless of whether it is recently updated or not. If an update already occurred, the consumer always receives the updated value.

Another mechanism for dealing with this second scenario involves extending the functionality of store instructions/operations, such that a monitor is automatically established on a consumer's behalf if a stored value reaches the monitored memory (e.g., L2 cache) before a subscription is received. When the subscription arrives at the monitored memory, the monitor is already established, and the current value is returned. With this mechanism, the automatically established monitor resource may be automatically deleted after the update is reported to the consumer.

The disclosed mechanisms comprise an instruction herein referred to as LDSUB.COUNT. This instruction may obviate the need for memory fences for producer-consumer synchronization. Using this instruction, a consumer may subscribe to an address range that implements monitors in all L2 slices or other memory partitions, depending on the implementation.

### LDSUB.COUNT

### Arguments

Global address (start address)
Address range (size of observed range)
Local address (for counter)
Options:
   Persistent monitor: entry is not deleted upon receiving updates from the producer.

### Returns: Nothing

An operand of this instruction specifies a local memory address for storing a count of updates to the subscribed address range. The monitor subscription request may be broadcast to each memory partition that may receive and monitor updates to the subscribed address range, e.g., to all slices of an L2 cache.

Once the monitor is established, incoming updates (store instructions) to the memory in the address range are recorded by each active monitor and counted. For a distributed memory with multiple partitions, a single partition may only observe and count a subset of the updates when the monitored range spans partitions. The monitors may communicate counter updates to the configured memory addresses for the count upon occurrence of the updates, or at regular time intervals. The counters may be updated using atomic ADD operations.

The number of counter updates communicated to subscribers may be reduced using various mechanisms. For example, instead of configuring a fixed time interval for sending counter updates, a rate at which the counter changes may be monitored, and updates only sent once the rate falls below a configured threshold.

### LDSUB.NUM_SUBS

This operation queries whether a monitor for a given address exists, and if so, how many subscribers it has.

### Arguments

Global address (start address of range, or single location)
Returns: Number of subscribers for the provided address, or 0 if no monitors for the address exist

### LDSUB.GET

This operation instantiates a monitor for a given address range and provides memory local to the subscribing consumer of the same size as the monitored range. Incoming updates to the subscribed range are then reflected by the monitor into the local storage locations of the subscribed consumers.

For multicast operations in which multiple consumers are subscribed to the same address range, a symmetric shared memory allocation may be utilized. Multicast subscriptions may therefore be constrained to a single processor execution domain. If the subscription request is received after generation of data by the producer that is subscribed to, and publishing is implemented (see STORE. PUBLISH), this operation may resort to counting updates to the subscribed location.

### Arguments

Global address (start address)
Address range (size of observed range)
Local address (start address)

### Returns: Nothing

### STORE.PUBLISH

This operation implements counting of subscribed producer activity. Counting is useful in situations in which monitors on address ranges are established after store operations by producers to those locations take place. This operation enables monitors to be established that don't lose track of updates that take place before the monitors are established.

### Arguments

Store offset
Store data
Global address range (base address)
Address range (size of observed range)

Some embodiments of consumer/producer interactions may utilize counters. Notifications involving counters may be implemented in a number of different manners, such as:
Immediate notification of counter updates;
Periodic notifications of counter updates;
A subscription to a count may include an expected count value, and a notification is provided once the count reaches the expected value.

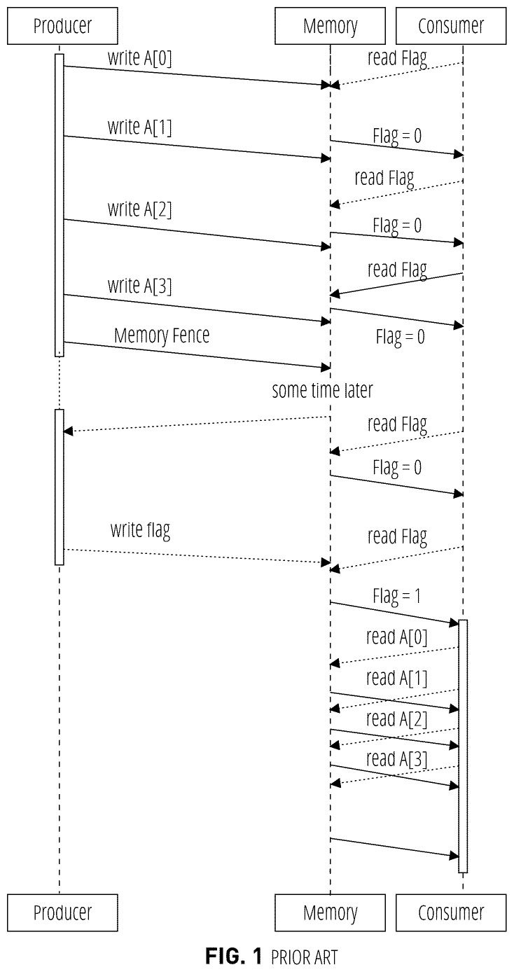

FIG. 1 depicts a conventional consumer/producer memory interaction. A data producer process writes a number of values to addresses A[0]-A[3] of a memory. A consumer process that is waiting for these values in order to make execution progress polls (checks and rechecks) a memory location comprising a flag value. The flag value remains at zero until all of the data values are written to the memory by the producer, at which point the producer sets the flag to one, indicating that the data the consumer is waiting for is now all available. The next time the consumer checks the flag it detects the new value of the flag and reads the data values from the memory.

A producer may establish a “fence” to ensure that the flag becomes visible only after the data is visible. The consumer polls for the flag, and once the flag is visible to the consumer, it reads the data. The fence ensures the data is valid at the time when the flag is updated. The use of the memory fence in this manner may reduce the computational performance of the consumer process.

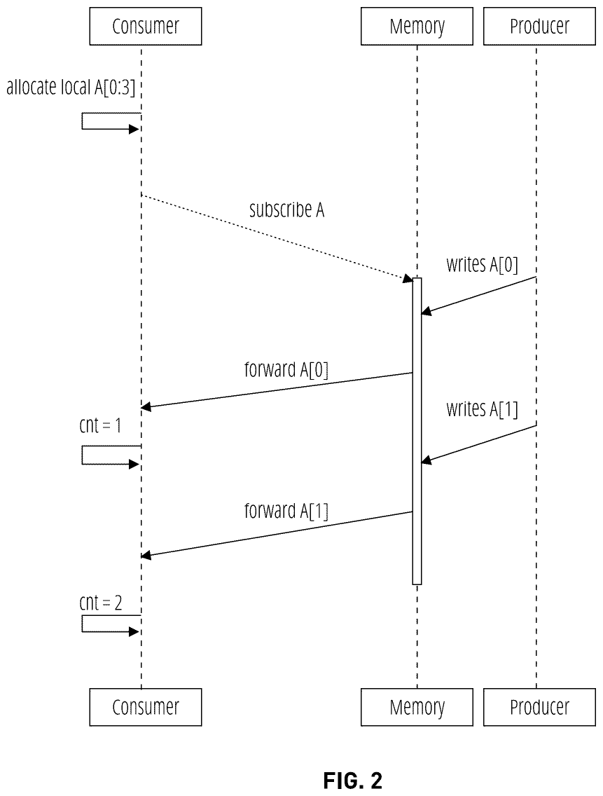

FIG. 2 depicts a consumer/producer interaction in accordance with another embodiment. The consumer subscribes to the memory addresses into which the producer writes the data the consumer needs. Each time the producer writes a new piece of the data (in address order) the memory forwards the data to the consumer and the consumer increments a counter. Once the counter reaches a number of addresses in the range it subscribed to, the consumer may signal the memory to release the subscription, freeing up the subscription overhead.

The consumer will not miss any data so long as the subscription request from the consumer to the memory arrives before the producer writes to any of the subscribed addresses.

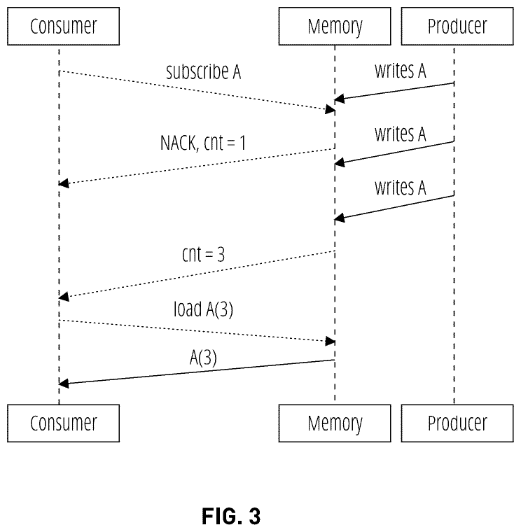

FIG. 3 depicts a consumer/producer interaction in accordance with another embodiment. This embodiment accounts for situations in which the consumer subscribes to the memory range after the producer has already written at least one address of the subscribed range. To handle this type of scenario the memory logic may utilize a counter to track a number of the subscribed addresses written by the producer. The memory may return this counter value to the subscribing consumer along with an acknowledgement that the subscription has been established. Subsequently as the producer writes to additional addresses in the subscribed range, the memory forwards to the consumer updates of the count. Once the count reaches a particular value the consumer may read some or all of the data at the subscribed addresses.

In another embodiment, the memory may comprise a bit mask to track which addresses in a subscribed range are written. When the subscription is established, it may forward the mask to the subscriber, which can determine from the mask which elements were previously written and take appropriate action. This embodiment may be suitable for implementations wherein subscription ranges are of a fixed size, or more generally, bounded in size.

In yet another embodiment, a count is maintained of a number of stores. When a subscription is established, the count is consulted to determined previously written elements, and previously written elements meeting the subscription parameters are forwarded to the subscriber. This embodiment may be suitable for implementations wherein the stores guaranteed to arrive in an ordered fashion at the memory.

A cache memory slice refers to a portion of the cache memory that operates as an independent unit within a multi-core processor architecture. In modern processors, caches are often divided into slices to enhance parallel data access and improve overall processing efficiency. Each slice can handle data from specific memory addresses, determined by a hashing function, and multiple slices can be accessed concurrently by different processor cores. This organization helps in reducing contention and latency, thereby optimizing performance in multi-threaded and multi-core systems.

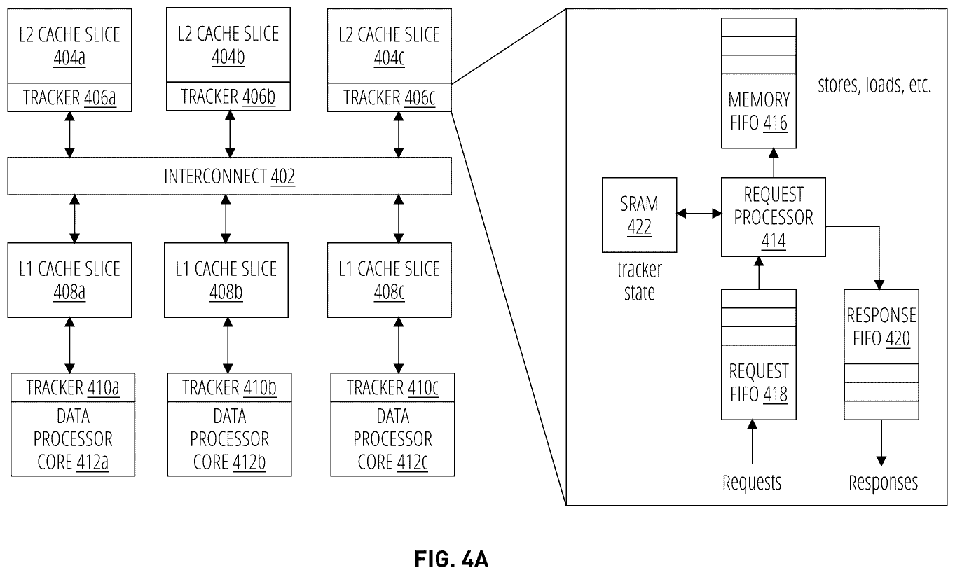

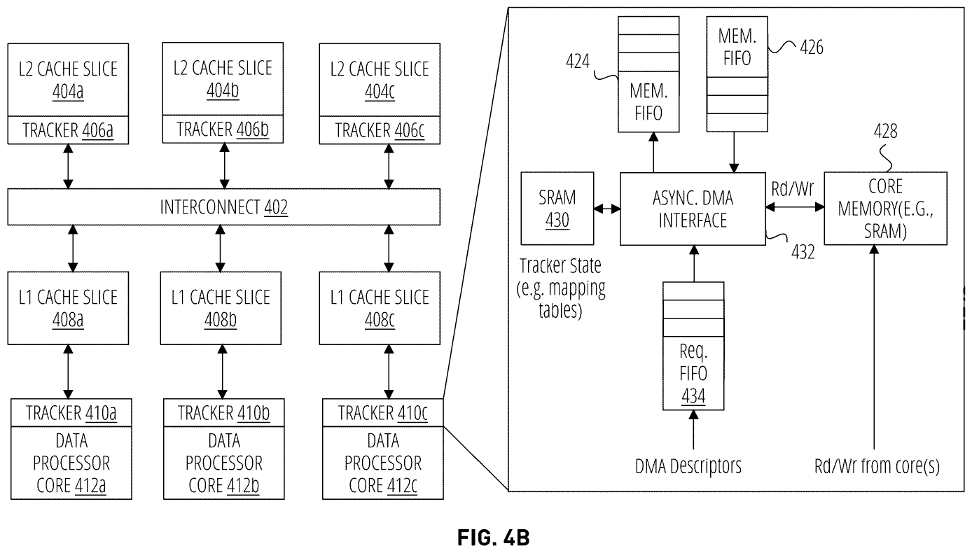

FIG. 4A-FIG. 4B depict a computing system in accordance with one embodiment.

The system comprises an interconnect 402, a Level 2 (L2) cache memory [404a, 404b, 404c] comprising tracking logic 406a, 406b, 406c, a Level 1 (L1) cache memory [408a, 408b, 408c], and tracking logic 410a, 410b, tracking logic 410c for multiple data processor cores 412a, 412b, data processor core 412c.

The tracking logic 406a, 406b, 406c for each L2 cache slice 404a, 404b, 404c may comprise a request processor 414, a memory FIFO 416, a request FIFO 418, a response FIFO 420, and a memory 422 for storing tracker state (e.g., SRAM or associative memory).

The tracking logic 410a 410b, 410c, for each L1 cache slice 408a, 408b, 408c may comprise a memory FIFO 424, a memory FIFO 426, a core internal memory 428, an SRAM 430, a DMA interface 432, and a request FIFO 434.

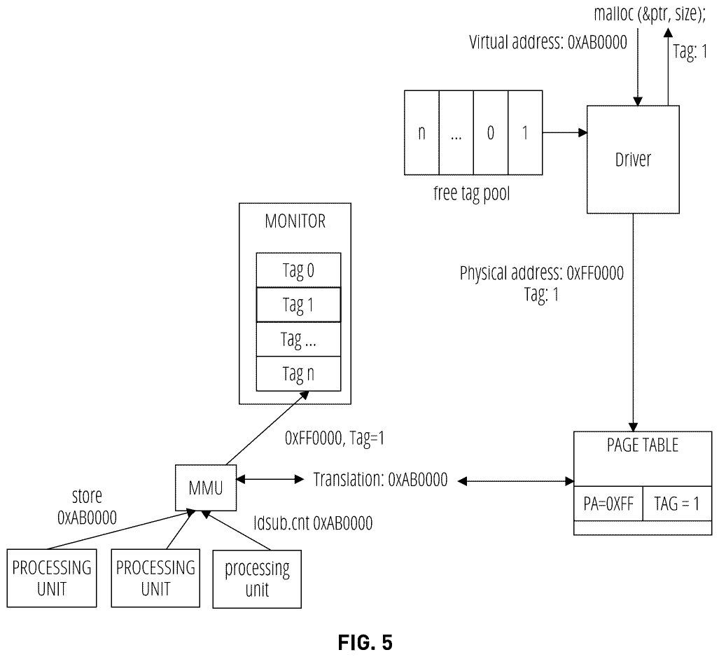

FIG. 5 depicts an example implementation of tags for use with monitored addresses and address ranges. Modified allocation logic (e.g., an operating system device driver) may be invoked by a function call (e.g., malloc(&base_pointer, size)) to associate a tag with the allocated memory region. The tag value to associate with the allocated memory may be drawn from a free pool of available tags that are not assigned to other memory regions. The virtual address provided to the allocation logic may be translated to a physical address and associated with the tag in the system memory page tables. The tags may be inserted into subsequent requests to establish monitors, and into monitor notifications.

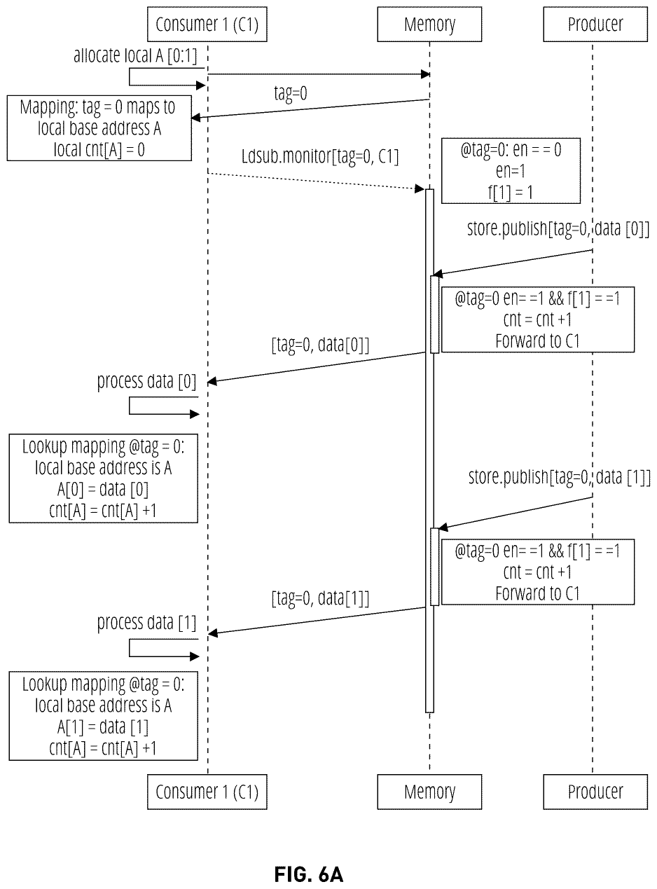

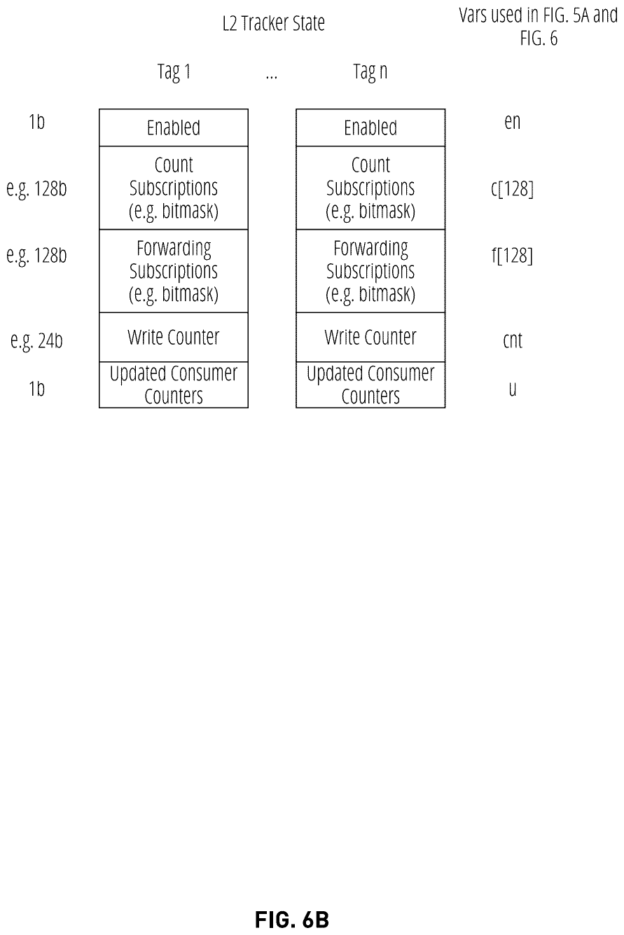

FIG. 6A-FIG. 6B depict a consumer/producer interaction utilizing subscription mechanisms in accordance with one embodiment. The consumer (Consumer 1, i.e. C1) allocates a local two-element array with a base address of A and configures a tag association with address A (e.g., tag=0 associates to address A). The consumer submits a subscription request to the memory that references the tag value.

Some time later, the producer publishes a data value data[0] to the memory in association with the tag having value zero. The memory updates a tracking counter for the tag value and forwards the published data value to the consumer along with the tag value. The tracking counter enables the system to handle subscriptions that occur after some data has already been written. The tracking counter can also be used as a means to determine when to deallocate memory tracking resources. The consumer utilizes the tag value and a tracking counter to store the data value in the first element of array A. This process is repeated for a second data value data[1] that is published by the producer.

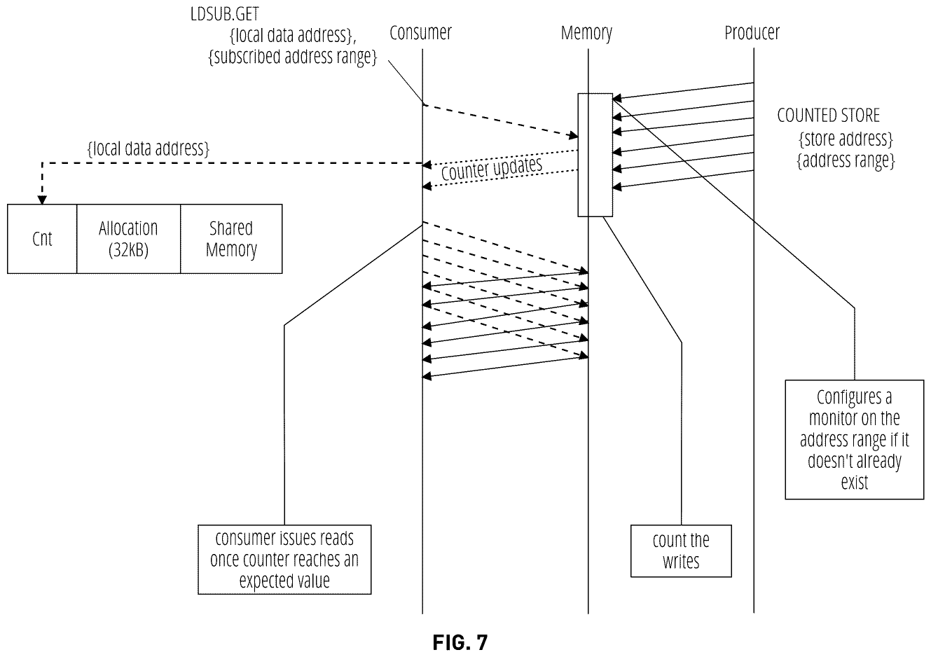

FIG. 7 depicts a consumer/producer interaction in accordance with an embodiment utilizing counted stores. Counted stores (e.g., deferred update notifications) may be effective at reducing memory traffic, especially in execution scenarios in which the producer generates a large number of store operations in a short interval of time. The subscription request configures the monitor with the address range to monitor for stores, and a local address into which to update a counter of the stores.

An instruction similar to store. publish may be utilized for this consumer interaction.

However, data is not forwarded in this scenario. The embodiment depicted in FIG. 7 may find utilize in avoiding pre-allocations of memory on the consumer side (e.g. for long-latency operations that would maintain the allocations for an unacceptably long time).

The shared memory is local to the consumer. The consumer allocated from this memory to hold the data from the producer, which is read after the count reaches a threshold value.

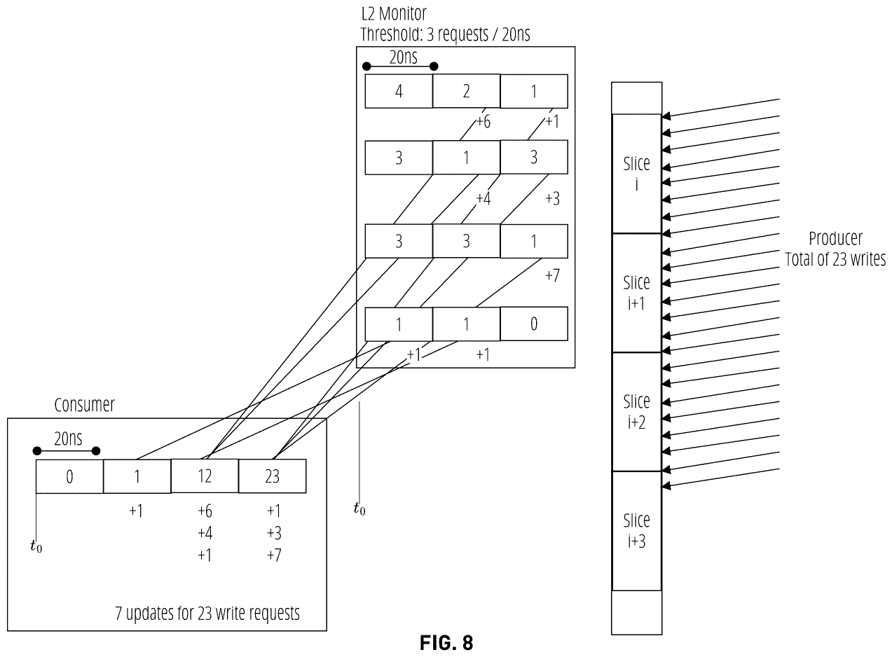

FIG. 8 depicts an example of deferred update notification. A producer generates a total of 23 writes across multiple slices of an L2 cache memory. A consumer configures a monitor on the L2 memory that generates notifications of a number of writes that occurred every 20 nanoseconds or every 3 writes, whichever occurs first. The consumer receives only 7 updates for the 23 writes by the producer, conserving memory bandwidth. As in previous examples, the updates may comprise the data written by the producer, or counter values, depending on how the monitor is configured.

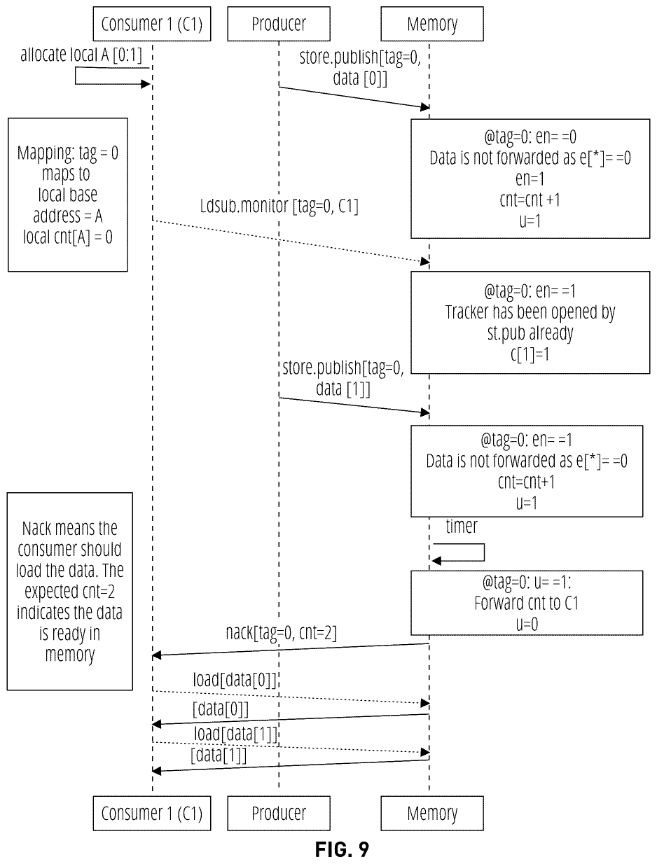

FIG. 9 depicts a consumer/producer interaction in accordance with another embodiment. In this interaction the producer writes a data value of interest to the consumer before the consumer submits a subscription for the data to the memory. The memory does not forward the data value to the consumer upon receipt for this reason but does allocate a tracker for the published data and associated tag value. The memory waits for a period of time, as more data values associated with the tag are published, and then forwards the tracking counter for tag=0 to the consumer. The consumer then loads the two published data values from the memory. In FIG. 9, addresses for data[0] and data[1] are agreed upon between producer and consumer (e.g. a pointer to a shared memory location). The notation e[*]==0 indicates that there is not a subscription for the given tag when the store arrives.

Although there was an existing subscription when the second store arrived, because the first store was already counted, the count may optionally continue without forwarding any data. The data may be forwarded, but then the consumer may have to track which data it got forwarded and which was missing (this should be an embodiment).

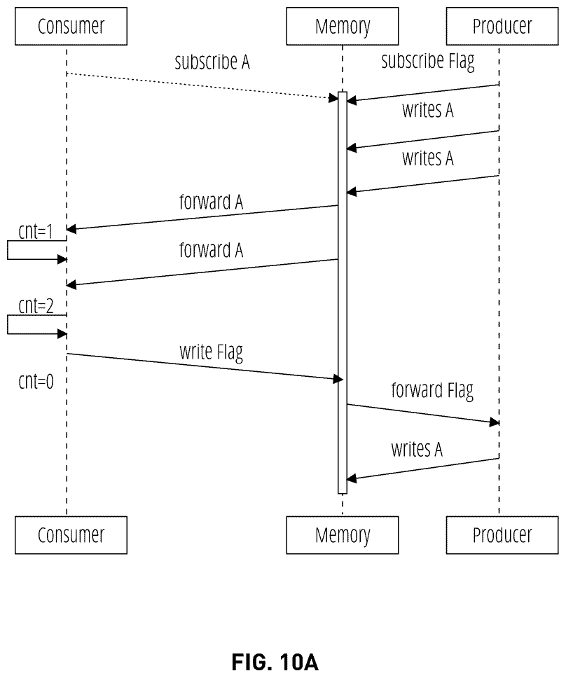

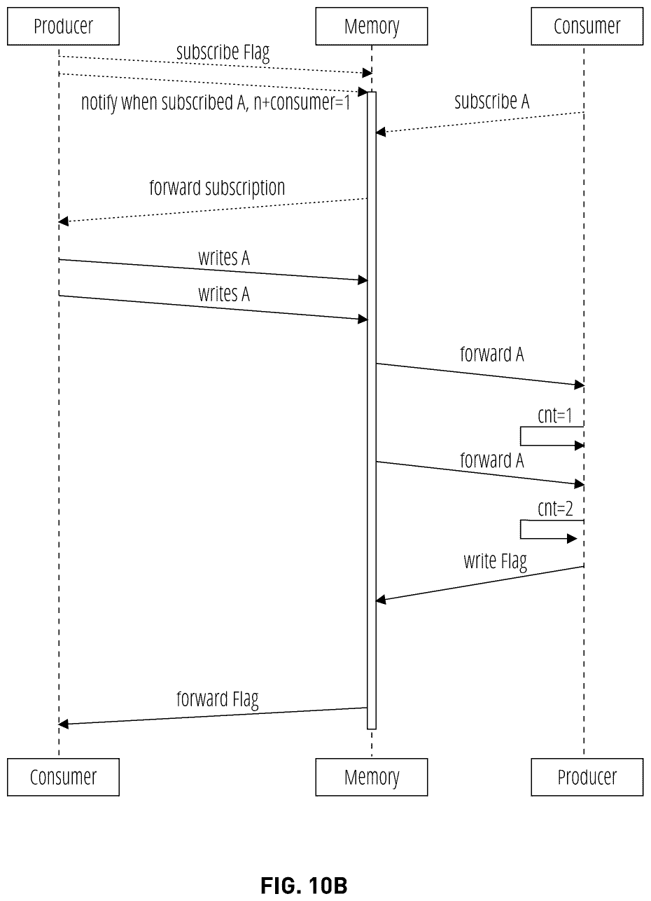

FIG. 10A depicts a consumer/producer interaction in accordance with another embodiment. This interaction may be utilized to implement a simple recycled buffer structure.

A recycled buffer efficiently handles continuous data streams by overwriting the oldest data when the buffer is full, which is useful for situations like data streaming or implementing queues.

In FIG. 10A, both of the consumer and producer subscribe to the memory. The consumer subscribes to the address of the buffer (A) and the producer subscribes to a flag that indicates that data in the buffer can be overwritten. The producer fills the buffer with data and the memory forwards the data to the consumer. The consumer counts the data values forwarded to it and writes the flag to the memory when it receives them all. The memory forwards the flag to the producer which may then overwrite the contents of the buffer with new data values.

FIG. 10B depicts a consumer/producer interaction in accordance with another embodiment. This interaction may also be utilized to implement a recycled buffer structure. The interaction depicted in FIG. 10B is similar to that of FIG. 10A, except that the producer is notified of the consumer's subscription, and only begins writing the data once it receives the notification.

The handshake mechanism depicted in FIG. 10A and FIG. 10B may also be utilized to implement multi-buffering applications, for example, double buffering.

In a double-buffering implementation, a producer writes data to a first buffer, e.g., A0. A consumer will eventually consume the data in A0 and set a flag indicating it has consumed A0 and A0 can be reused. While the producer waits for the flag indicating consumption of A0 to be set, the producer can write data to a second buffer, A1. Once the flag for A0 is set, the producer can switch back to writing data to A0 while waiting for the consumer to consume A1 and set the flag indicating consumption of A1 to be set.

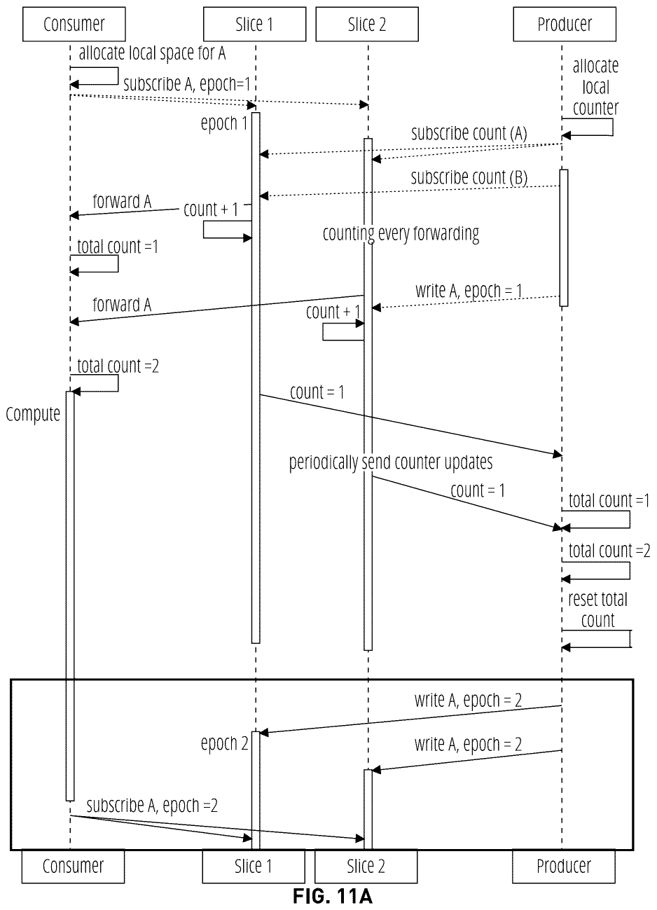

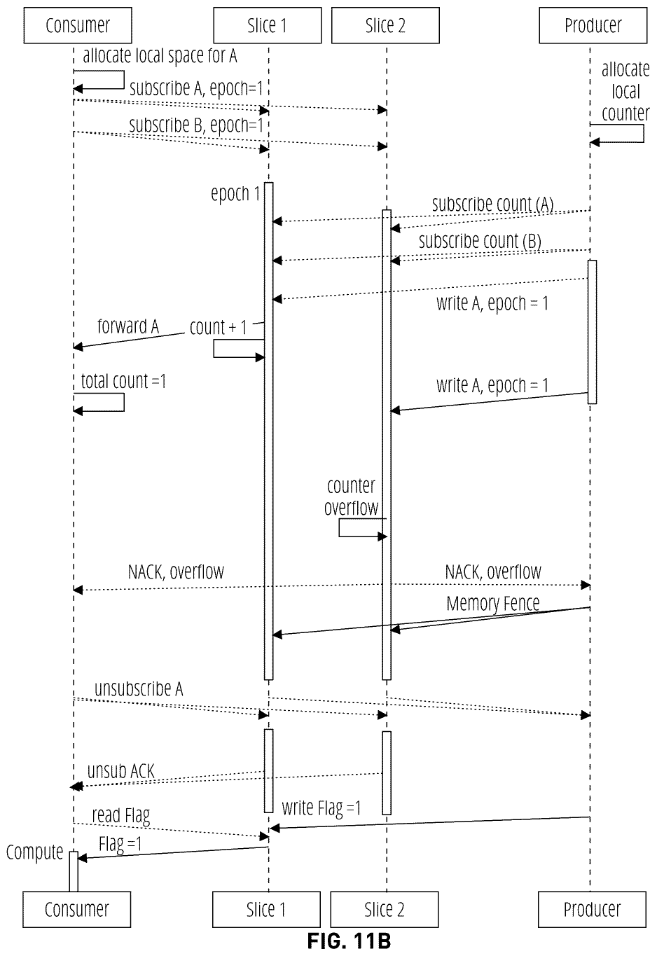

FIG. 11A-FIG. 11B depict consumer/producer interactions in accordance with different embodiments. These interactions may be utilized for training a machine learning model over many epochs. An epoch in machine learning refers to one complete pass through the entire training dataset during the training process of a model. During an epoch, the algorithm processes each sample in the dataset exactly once, adjusting the model's weights to minimize error. Multiple epochs are typically used to ensure the model converges to an optimal solution, improving its accuracy and generalization abilities over time.

To reduce latency, in these scenarios a counter is implemented to count how many consumptions of the written data the consumer has completed. The producer allocates a counter in local memory, and it submits a subscription request for the count to the memory system. The count is basically how many times the memory system has forwarded data to the consumer. Whenever the memory system forwards the subscribed data to the consumer, it updates the counter in the producer. Updates to the the counter may be made as they occur, or periodically. In one embodiment, when the producer subscribes to the count, it may provide an expected value, and the memory system will only update the count in the producer once it reaches the expected value.

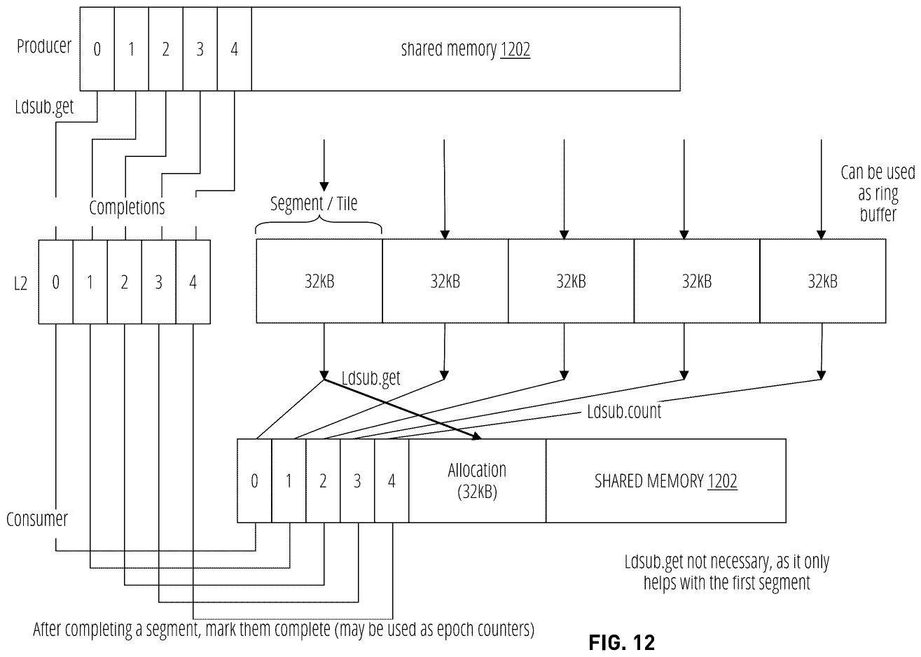

FIG. 12 depicts a producer/consumer ring buffer implementation in one embodiment. Consumers may allocate local memory (e.g. in shared memory 1202) to hold a segment of the ring buffer and a local flag location for each of the ring buffer's segments. On the consumer side, a ldsub.get may be issued for the head segment of the ring buffer, for example. The consumer may additionally issue ldsub.count operations for all segments.

The producer may allocate a flag for each of the segments. The flags indicate which segments have been read. The producers may also issue ldsub. get operations for a global flag location, which will later be set by the consumers upon consuming segments. When a producer writes into a segment which has not been read (e.g. starting with the head segment), the data may forwarded to the consumer that has subscribed to that particular segment, or, the shared memory 1202 will count and update the counters at the consumers.

Upon consuming the data, the consumer may set the completion flag in the globally visible shared memory 1202. This completion flag may be forwarded to the producer, indicating that the segment is free to be written again. While consuming the local data, the consumer may check if other segments have also been written already and, if so, start loading these other segments. Producers may continue writing segments as long as there are free segments available. If producers and consumers are rate-matched, they may constantly write and read data from the ring buffer without incurring wait latency.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, e.g., in or in conjunction with a level two cache 1502 and/or shared memory/L1 cache 1602.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar”refers to a “crossbar”.

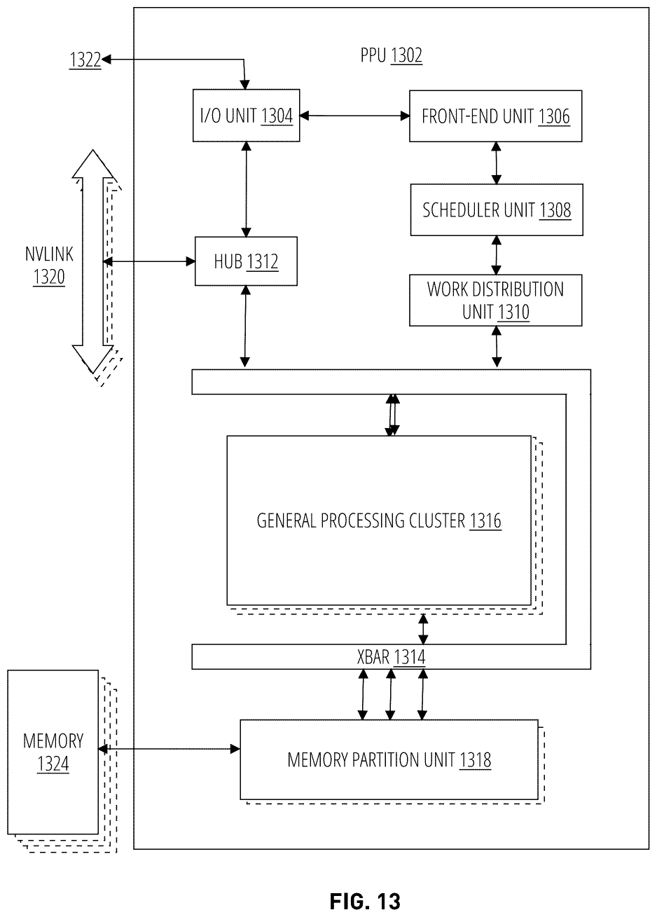

FIG. 13 depicts a parallel processing unit 1302, in accordance with an embodiment. In an embodiment, the parallel processing unit 1302 is a multi-threaded processor that is implemented on one or more integrated circuit devices. The parallel processing unit 1302 is a latency hiding architecture designed to process many threads in parallel. A thread (e.g., a thread of execution) is an instantiation of a set of instructions configured to be executed by the parallel processing unit 1302. In an embodiment, the parallel processing unit 1302 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 1302 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 1302 modules may be configured to accelerate thousands of High Performance Computing (HPC), data center, and machine learning applications. The parallel processing unit 1302 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 13, the parallel processing unit 1302 includes an I/O unit 1304, a front-end unit 1306, a scheduler unit 1308, a work distribution unit 1310, a hub 1312, a crossbar 1314, one or more general processing cluster 1316 modules, and one or more memory partition unit 1318 modules. The parallel processing unit 1302 may be connected to a host processor or other parallel processing unit 1302 modules via one or more high-speed NVLink 1320 interconnects. The parallel processing unit 1302 may be connected to a host processor or other peripheral devices via an interconnect 1322. The parallel processing unit 1302 may also be connected to a local memory comprising a number of memory 1324 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 1324 may comprise logic to configure the parallel processing unit 1302 to carry out aspects of the techniques disclosed herein.

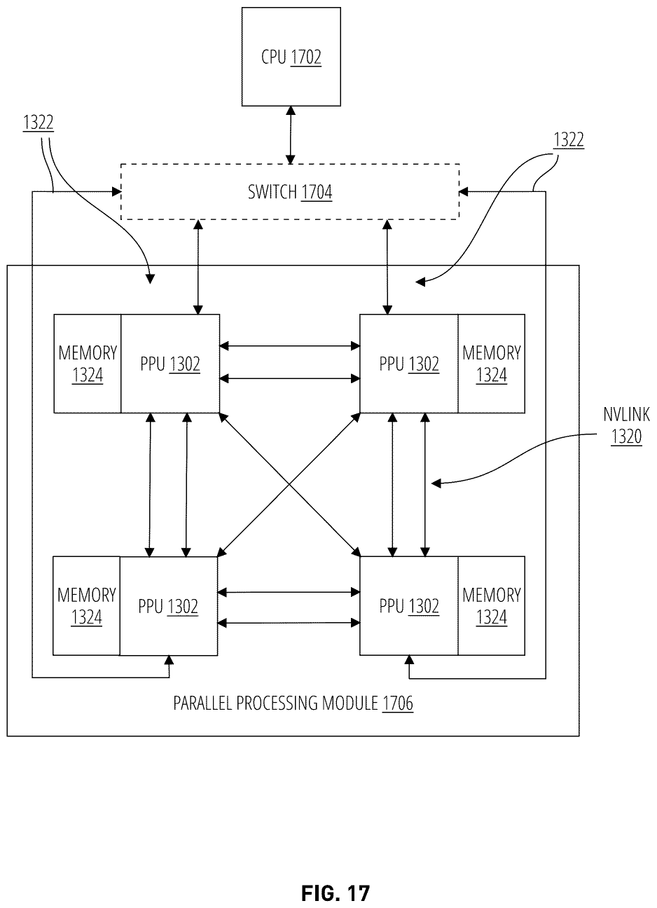

The NVLink 1320 interconnect enables systems to scale and include one or more parallel processing unit 1302 modules combined with one or more CPUs, supports cache coherence between the parallel processing unit 1302 modules and CPUs, and CPU mastering. Data and/or commands may be transmitted by the NVLink 1320 through the hub 1312 to/from other units of the parallel processing unit 1302 such as one or more copy engines, a video encoder, a video decoder, a power management unit, etc. (not explicitly shown). The NVLink 1320 is described in more detail in conjunction with FIG. 17.

The I/O unit 1304 is configured to transmit and receive communications (e.g., commands, data, etc.) from a host processor (not shown) over the interconnect 1322. The I/O unit 1304 may communicate with the host processor directly via the interconnect 1322 or through one or more intermediate devices such as a memory bridge. In an embodiment, the I/O unit 1304 may communicate with one or more other processors, such as one or more parallel processing unit 1302 modules via the interconnect 1322. In an embodiment, the I/O unit 1304 implements a Peripheral Component Interconnect Express (PCIe) interface for communications over a PCIe bus and the interconnect 1322 is a PCIe bus. In alternative embodiments, the I/O unit 1304 may implement other types of well-known interfaces for communicating with external devices.

The I/O unit 1304 decodes packets received via the interconnect 1322. In an embodiment, the packets represent commands configured to cause the parallel processing unit 1302 to perform various operations. The I/O unit 1304 transmits the decoded commands to various other units of the parallel processing unit 1302 as the commands may specify. For example, some commands may be transmitted to the front-end unit 1306. Other commands may be transmitted to the hub 1312 or other units of the parallel processing unit 1302 such as one or more copy engines, a video encoder, a video decoder, a power management unit, etc. (not explicitly shown). In other words, the I/O unit 1304 is configured to route communications between and among the various logical units of the parallel processing unit 1302.

In an embodiment, a program executed by the host processor encodes a command stream in a buffer that provides workloads to the parallel processing unit 1302 for processing. A workload may comprise several instructions and data to be processed by those instructions. The buffer is a region in a memory that is accessible (e.g., read/write) by both the host processor and the parallel processing unit 1302. For example, the I/O unit 1304 may be configured to access the buffer in a system memory connected to the interconnect 1322 via memory requests transmitted over the interconnect 1322. In an embodiment, the host processor writes the command stream to the buffer and then transmits a pointer to the start of the command stream to the parallel processing unit 1302. The front-end unit 1306 receives pointers to one or more command streams. The front-end unit 1306 manages the one or more streams, reading commands from the streams and forwarding commands to the various units of the parallel processing unit 1302.

The front-end unit 1306 is coupled to a scheduler unit 1308 that configures the various general processing cluster 1316 modules to process tasks defined by the one or more streams. The scheduler unit 1308 is configured to track state information related to the various tasks managed by the scheduler unit 1308. The state may indicate which general processing cluster 1316 a task is assigned to, whether the task is active or inactive, a priority level associated with the task, and so forth. The scheduler unit 1308 manages the execution of a plurality of tasks on the one or more general processing cluster 1316 modules.

The scheduler unit 1308 is coupled to a work distribution unit 1310 that is configured to dispatch tasks for execution on the general processing cluster 1316 modules. The work distribution unit 1310 may track a number of scheduled tasks received from the scheduler unit 1308. In an embodiment, the work distribution unit 1310 manages a pending task pool and an active task pool for each of the general processing cluster 1316 modules. The pending task pool may comprise a number of slots (e.g., 32 slots) that contain tasks assigned to be processed by a particular general processing cluster 1316. The active task pool may comprise a number of slots (e.g., 4 slots) for tasks that are actively being processed by the general processing cluster 1316 modules. As a general processing cluster 1316 finishes the execution of a task, that task is evicted from the active task pool for the general processing cluster 1316 and one of the other tasks from the pending task pool is selected and scheduled for execution on the general processing cluster 1316. If an active task has been idle on the general processing cluster 1316, such as while waiting for a data dependency to be resolved, then the active task may be evicted from the general processing cluster 1316 and returned to the pending task pool while another task in the pending task pool is selected and scheduled for execution on the general processing cluster 1316.

The work distribution unit 1310 communicates with the one or more general processing cluster 1316 modules via crossbar 1314. The crossbar 1314 is an interconnect network that couples many of the units of the parallel processing unit 1302 to other units of the parallel processing unit 1302. For example, the crossbar 1314 may be configured to couple the work distribution unit 1310 to a particular general processing cluster 1316. Although not shown explicitly, one or more other units of the parallel processing unit 1302 may also be connected to the crossbar 1314 via the hub 1312.

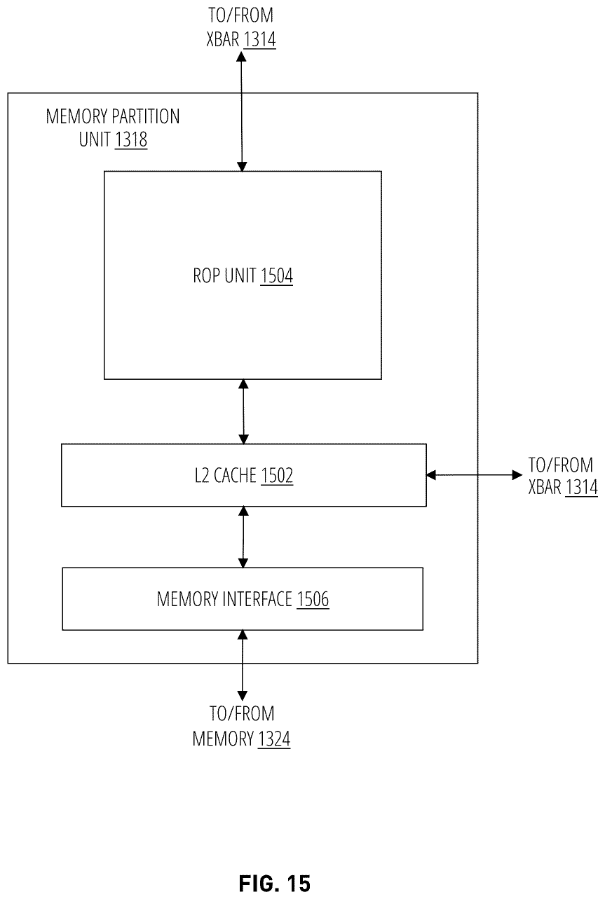

The tasks are managed by the scheduler unit 1308 and dispatched to a general processing cluster 1316 by the work distribution unit 1310. The general processing cluster 1316 is configured to process the task and generate results. The results may be consumed by other tasks within the general processing cluster 1316, routed to a different general processing cluster 1316 via the crossbar 1314, or stored in the memory 1324. The results can be written to the memory 1324 via the memory partition unit 1318 modules, which implement a memory interface for reading and writing data to/from the memory 1324. The results can be transmitted to another parallel processing unit 1302 or CPU via the NVLink 1320. In an embodiment, the parallel processing unit 1302 includes a number U of memory partition unit 1318 modules that is equal to the number of separate and distinct memory 1324 devices coupled to the parallel processing unit 1302. A memory partition unit 1318 will be described in more detail below in conjunction with FIG. 15.

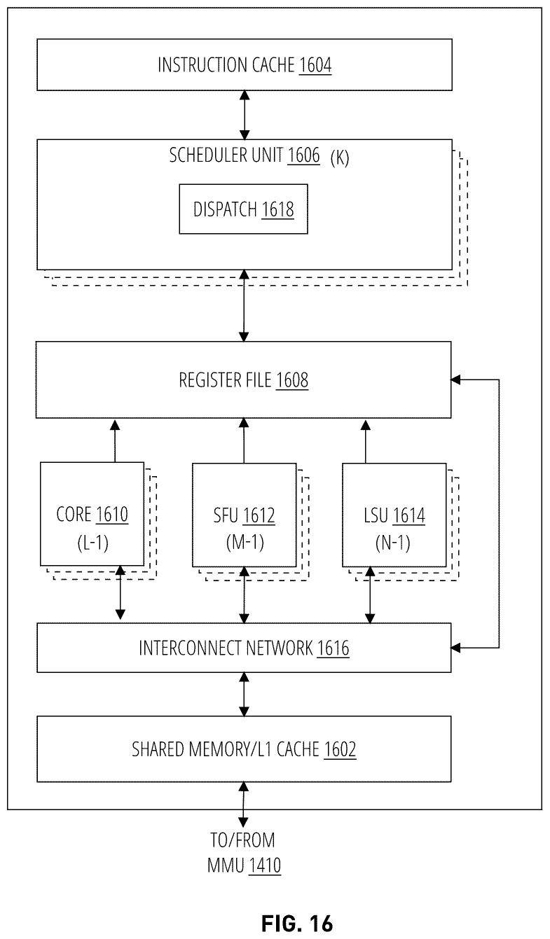

In an embodiment, a host processor executes a driver kernel that implements an application programming interface (API) that enables one or more applications executing on the host processor to schedule operations for execution on the parallel processing unit 1302. In an embodiment, multiple compute applications are simultaneously executed by the parallel processing unit 1302 and the parallel processing unit 1302 provides isolation, quality of service (QoS), and independent address spaces for the multiple compute applications. An application may generate instructions (e.g., API calls) that cause the driver kernel to generate one or more tasks for execution by the parallel processing unit 1302. The driver kernel outputs tasks to one or more streams being processed by the parallel processing unit 1302. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 16.

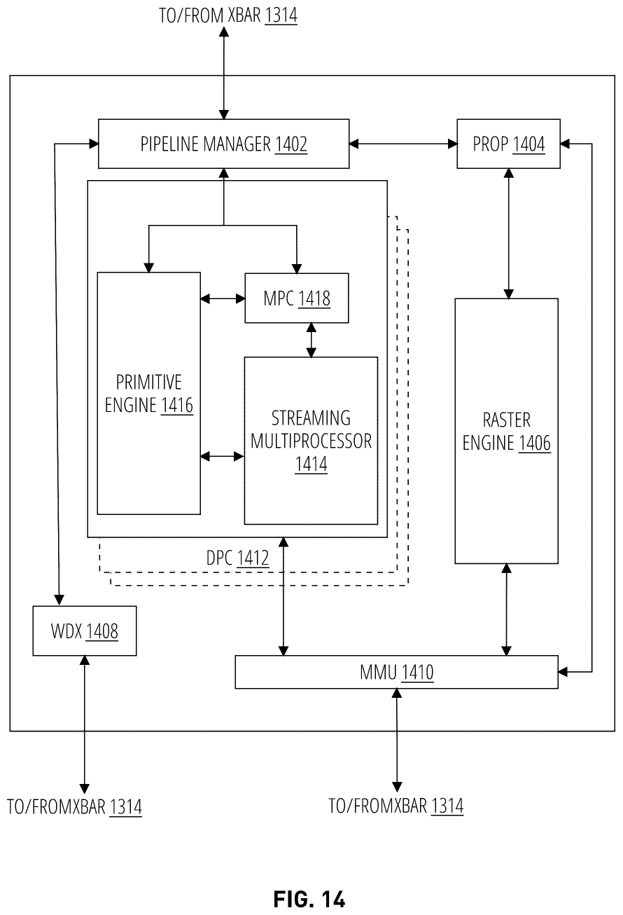

FIG. 14 depicts a general processing cluster 1316 of the parallel processing unit 1302 of FIG. 13, in accordance with an embodiment. As shown in FIG. 14, each general processing cluster 1316 includes a number of hardware units for processing tasks. In an embodiment, each general processing cluster 1316 includes a pipeline manager 1402, a pre-raster operations unit 1404, a raster engine 1406, a work distribution crossbar 1408, a memory management unit 1410, and one or more data processing cluster 1412. It will be appreciated that the general processing cluster 1316 of FIG. 14 may include other hardware units in lieu of or in addition to the units shown in FIG. 14.

In an embodiment, the operation of the general processing cluster 1316 is controlled by the pipeline manager 1402. The pipeline manager 1402 manages the configuration of the one or more data processing cluster 1412 modules for processing tasks allocated to the general processing cluster 1316. In an embodiment, the pipeline manager 1402 may configure at least one of the one or more data processing cluster 1412 modules to implement at least a portion of a graphics rendering pipeline. For example, a data processing cluster 1412 may be configured to execute a vertex shader program on the programmable streaming multiprocessor 1414. The pipeline manager 1402 may also be configured to route packets received from the work distribution unit 1310 to the appropriate logical units within the general processing cluster 1316. For example, some packets may be routed to fixed function hardware units in the pre-raster operations unit 1404 and/or raster engine 1406 while other packets may be routed to the data processing cluster 1412 modules for processing by the primitive engine 1416 or the streaming multiprocessor 1414. In an embodiment, the pipeline manager 1402 may configure at least one of the one or more data processing cluster 1412 modules to implement a neural network model and/or a computing pipeline.

The pre-raster operations unit 1404 is configured to route data generated by the raster engine 1406 and the data processing cluster 1412 modules to a Raster Operations (ROP) unit, described in more detail in conjunction with FIG. 15. The pre-raster operations unit 1404 may also be configured to perform optimizations for color blending, organize pixel data, perform address translations, and the like.

The raster engine 1406 includes a number of fixed function hardware units configured to perform various raster operations. In an embodiment, the raster engine 1406 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1406 comprises fragments to be processed, for example, by a fragment shader implemented within a data processing cluster 1412.

Each data processing cluster 1412 included in the general processing cluster 1316 includes an M-pipe controller 1418, a primitive engine 1416, and one or more streaming multiprocessor 1414 modules. The M-pipe controller 1418 controls the operation of the data processing cluster 1412, routing packets received from the pipeline manager 1402 to the appropriate units in the data processing cluster 1412. For example, packets associated with a vertex may be routed to the primitive engine 1416, which is configured to fetch vertex attributes associated with the vertex from the memory 1324. In contrast, packets associated with a shader program may be transmitted to the streaming multiprocessor 1414.

The streaming multiprocessor 1414 comprises a programmable streaming processor that is configured to process tasks represented by a number of threads. Each streaming multiprocessor 1414 is multi-threaded and configured to execute a plurality of threads (e.g., 32 threads) from a particular group of threads concurrently. In an embodiment, the streaming multiprocessor 1414 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1414 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1414 will be described in more detail below in conjunction with FIG. 16.

The memory management unit 1410 provides an interface between the general processing cluster 1316 and the memory partition unit 1318. The memory management unit 1410 may provide translation of virtual addresses into physical addresses, memory protection, and arbitration of memory requests. In an embodiment, the memory management unit 1410 provides one or more translation lookaside buffers (TLBs) for performing translation of virtual addresses into physical addresses in the memory 1324.

FIG. 15 depicts a memory partition unit 1318 of the parallel processing unit 1302 of FIG. 13, in accordance with an embodiment. As shown in FIG. 15, the memory partition unit 1318 includes a raster operations unit 1504, a level two cache 1502, and a memory interface 1506. The memory interface 1506 is coupled to the memory 1324. Memory interface 1506 may implement 32, 64, 128, 1024-bit data buses, or the like, for high-speed data transfer. In an embodiment, the parallel processing unit 1302 incorporates U memory interface 1506 modules, one memory interface 1506 per pair of memory partition unit 1318 modules, where each pair of memory partition unit 1318 modules is connected to a corresponding memory 1324 device. For example, parallel processing unit 1302 may be connected to up to Y memory 1324 devices, such as high bandwidth memory stacks or graphics double-data-rate, version 5, synchronous dynamic random access memory, or other types of persistent storage.

In an embodiment, the memory interface 1506 implements an HBM2 memory interface and Y equals half U. In an embodiment, the HBM2 memory stacks are located on the same physical package as the parallel processing unit 1302, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1324 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 1302 modules process very large datasets and/or run applications for extended periods.

In an embodiment, the parallel processing unit 1302 implements a multi-level memory hierarchy. In an embodiment, the memory partition unit 1318 supports a unified memory to provide a single unified virtual address space for CPU and parallel processing unit 1302 memory, enabling data sharing between virtual memory systems. In an embodiment the frequency of accesses by a parallel processing unit 1302 to memory located on other processors is traced to ensure that memory pages are moved to the physical memory of the parallel processing unit 1302 that is accessing the pages more frequently. In an embodiment, the NVLink 1320 supports address translation services allowing the parallel processing unit 1302 to directly access a CPU's page tables and providing full access to CPU memory by the parallel processing unit 1302.

In an embodiment, copy engines transfer data between multiple parallel processing unit 1302 modules or between parallel processing unit 1302 modules and CPUs. The copy engines can generate page faults for addresses that are not mapped into the page tables. The memory partition unit 1318 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1324 or other system memory may be fetched by the memory partition unit 1318 and stored in the level two cache 1502, which is located on-chip and is shared between the various general processing cluster 1316 modules. As shown, each memory partition unit 1318 includes a portion of the level two cache 1502 associated with a corresponding memory 1324 device. Lower level caches may then be implemented in various units within the general processing cluster 1316 modules. For example, each of the streaming multiprocessor 1414 modules may implement an L1 cache. The L1 cache is private memory that is dedicated to a particular streaming multiprocessor 1414. Data from the level two cache 1502 may be fetched and stored in each of the L1 caches for processing in the functional units of the streaming multiprocessor 1414 modules. The level two cache 1502 is coupled to the memory interface 1506 and the crossbar 1314.

The raster operations unit 1504 performs graphics raster operations related to pixel color, such as color compression, pixel blending, and the like. The raster operations unit 1504 also implements depth testing in conjunction with the raster engine 1406, receiving a depth for a sample location associated with a pixel fragment from the culling engine of the raster engine 1406. The depth is tested against a corresponding depth in a depth buffer for a sample location associated with the fragment. If the fragment passes the depth test for the sample location, then the raster operations unit 1504 updates the depth buffer and transmits a result of the depth test to the raster engine 1406. It will be appreciated that the number of partition memory partition unit 1318 modules may be different than the number of general processing cluster 1316 modules and, therefore, each raster operations unit 1504 may be coupled to each of the general processing cluster 1316 modules. The raster operations unit 1504 tracks packets received from the different general processing cluster 1316 modules and determines which general processing cluster 1 that a result generated by the raster operations unit 1504 is routed to through the crossbar 1314. Although the raster operations unit 1504 is included within the memory partition unit 1318 in FIG. 15, in other embodiment, the raster operations unit 1504 may be outside of the memory partition unit 1318. For example, the raster operations unit 1504 may reside in the general processing cluster 1316 or another unit.

FIG. 16 illustrates the streaming multiprocessor 1414 of FIG. 14, in accordance with an embodiment. As shown in FIG. 16, the streaming multiprocessor 1414 includes an instruction cache 1604, one or more scheduler unit 1606 modules (e.g., such as scheduler unit 1308), a register file 1608, one or more processing core 1610 modules, one or more special function unit 1612 modules, one or more load/store unit 1614 modules, an interconnect network 1616, and a shared memory/L1 cache 1602.

As described above, the work distribution unit 1310 dispatches tasks for execution on the general processing cluster 1316 modules of the parallel processing unit 1302. The tasks are allocated to a particular data processing cluster 1412 within a general processing cluster 1316 and, if the task is associated with a shader program, the task may be allocated to a streaming multiprocessor 1414. The scheduler unit 1308 receives the tasks from the work distribution unit 1310 and manages instruction scheduling for one or more thread blocks assigned to the streaming multiprocessor 1414. The scheduler unit 1606 schedules thread blocks for execution as warps of parallel threads, where each thread block is allocated at least one warp. In an embodiment, each warp executes 32 threads. The scheduler unit 1606 may manage a plurality of different thread blocks, allocating the warps to the different thread blocks and then dispatching instructions from the plurality of different cooperative groups to the various functional units (e.g., core 1610 modules, special function unit 1612 modules, and load/store unit 1614 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms.

Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1618 unit is configured within the scheduler unit 1606 to transmit instructions to one or more of the functional units. In one embodiment, the scheduler unit 1606 includes two dispatch 1618 units that enable two different instructions from the same warp to be dispatched during each clock cycle. In alternative embodiments, each scheduler unit 1606 may include a single dispatch 1618 unit or additional dispatch 1618 units.

Each streaming multiprocessor 1414 includes a register file 1608 that provides a set of registers for the functional units of the streaming multiprocessor 1414. In an embodiment, the register file 1608 is divided between each of the functional units such that each functional unit is allocated a dedicated portion of the register file 1608. In another embodiment, the register file 1608 is divided between the different warps being executed by the streaming multiprocessor 1414. The register file 1608 provides temporary storage for operands connected to the data paths of the functional units.

Each streaming multiprocessor 1414 comprises L processing core 1610 modules. In an embodiment, the streaming multiprocessor 1414 includes a large number (e.g., 128, etc.) of distinct processing core 1610 modules. Each core 1610 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1610 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1610 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1414 also comprises M special function unit 1612 modules that perform special functions (e.g., attribute evaluation, reciprocal square root, and the like). In an embodiment, the special function unit 1612 modules may include a tree traversal unit configured to traverse a hierarchical tree data structure. In an embodiment, the special function unit 1612 modules may include texture unit configured to perform texture map filtering operations. In an embodiment, the texture units are configured to load texture maps (e.g., a 2D array of texels) from the memory 1324 and sample the texture maps to produce sampled texture values for use in shader programs executed by the streaming multiprocessor 1414. In an embodiment, the texture maps are stored in the shared memory/L1 cache 1602. The texture units implement texture operations such as filtering operations using mip-maps (e.g., texture maps of varying levels of detail). In an embodiment, each streaming multiprocessor 1414 includes two texture units.

Each streaming multiprocessor 1414 also comprises N load/store unit 1614 modules that implement load and store operations between the shared memory/L1 cache 1602 and the register file 1608. Each streaming multiprocessor 1414 includes an interconnect network 1616 that connects each of the functional units to the register file 1608 and the load/store unit 1614 to the register file 1608 and shared memory/L1 cache 1602. In an embodiment, the interconnect network 1616 is a crossbar that can be configured to connect any of the functional units to any of the registers in the register file 1608 and connect the load/store unit 1614 modules to the register file 1608 and memory locations in shared memory/L1 cache 1602.

The shared memory/L1 cache 1602 is an array of on-chip memory that allows for data storage and communication between the streaming multiprocessor 1414 and the primitive engine 1416 and between threads in the streaming multiprocessor 1414. In an embodiment, the shared memory/L1 cache 1602 comprises 128 KB of storage capacity and is in the path from the streaming multiprocessor 1414 to the memory partition unit 1318. The shared memory/L1 cache 1602 can be used to cache reads and writes. One or more of the shared memory/L1 cache 1602, level two cache 1502, and memory 1324 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1602 enables the shared memory/L1 cache 1602 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 13, are bypassed, creating a much simpler programming model. In the general purpose parallel computation configuration, the work distribution unit 1310 assigns and distributes blocks of threads directly to the data processing cluster 1412 modules. The threads in a block execute the same program, using a unique thread ID in the calculation to ensure each thread generates unique results, using the streaming multiprocessor 1414 to execute the program and perform calculations, shared memory/L1 cache 1602 to communicate between threads, and the load/store unit 1614 to read and write global memory through the shared memory/L1 cache 1602 and the memory partition unit 1318. When configured for general purpose parallel computation, the streaming multiprocessor 1414 can also write commands that the scheduler unit 1308 can use to launch new work on the data processing cluster 1412 modules.

The parallel processing unit 1302 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 1302 is embodied on a single semiconductor substrate. In another embodiment, the parallel processing unit 1302 is included in a system-on-a-chip (SoC) along with one or more other devices such as additional parallel processing unit 1302 modules, the memory 1324, a reduced instruction set computer (RISC) CPU, a memory management unit (MMU), a digital-to-analog converter (DAC), and the like.

In an embodiment, the parallel processing unit 1302 may be included on a graphics card that includes one or more memory devices. The graphics card may be configured to interface with a PCIe slot on a motherboard of a desktop computer. In yet another embodiment, the parallel processing unit 1302 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 17 is a conceptual diagram of a processing system implemented using the parallel processing unit 1302 of FIG. 13, in accordance with an embodiment. The processing system includes a central processing unit 1702, an switch 1704, and multiple parallel processing unit 1302 modules each and respective memory 1324 modules. The switch 1704 is depicted with dashed lines, indicating that it is optional in some embodiments.

The NVLink 1320 provides high-speed communication links between each of the parallel processing unit 1302 modules. Although a particular number of NVLink 1320 and interconnect 1322 connections are illustrated in FIG. 17, the number of connections to each parallel processing unit 1302 and the central processing unit 1702 may vary. The switch 1704 interfaces between the interconnect 1322 and the central processing unit 1702. The parallel processing unit 1302 modules, memory 1324 modules, and NVLink 1320 connections may be situated on a single semiconductor platform to form a parallel processing module 1706. In an embodiment, the switch 1704 supports two or more protocols to interface between various different connections and/or links.

In another embodiment (not shown), the NVLink 1320 provides one or more high-speed communication links between each of the parallel processing unit modules (parallel processing unit 1302, parallel processing unit 1302, parallel processing unit 1302, and parallel processing unit 1302) and the central processing unit 1702 and the switch 1704 (when present) interfaces between the interconnect 1322 and each of the parallel processing unit modules. The parallel processing unit modules, memory 1324 modules, and interconnect 1322 may be situated on a single semiconductor platform to form a parallel processing module 1706. In yet another embodiment (not shown), the interconnect 1322 provides one or more communication links between each of the parallel processing unit modules and the central processing unit 1702 and the switch 1704 interfaces between each of the parallel processing unit modules using the NVLink 1320 to provide one or more high-speed communication links between the parallel processing unit modules. In another embodiment (not shown), the NVLink 1320 provides one or more high-speed communication links between the parallel processing unit modules and the central processing unit 1702 through the switch 1704. In yet another embodiment (not shown), the interconnect 1322 provides one or more communication links between each of the parallel processing unit modules directly. One or more of the NVLink 1320 high-speed communication links may be implemented as a physical NVLink interconnect or either an on-chip or on-die interconnect using the same protocol as the NVLink 1320.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1706 may be implemented as a circuit board substrate and each of the parallel processing unit modules and/or memory 1324 modules may be packaged devices. In an embodiment, the central processing unit 1702, switch 1704, and the parallel processing module 1706 are situated on a single semiconductor platform.

In an embodiment, each parallel processing unit module includes six NVLink 1320 interfaces (as shown in FIG. 17, five NVLink 1320 interfaces are included for each parallel processing unit module). The NVLink 1320 may be operated exclusively for PPU-to-PPU communication as shown in FIG. 17, or some combination of PPU-to-PPU and PPU-to-CPU, when the central processing unit 1702 also includes one or more NVLink 1320 interfaces.

In an embodiment, the NVLink 1320 allows direct load/store/atomic access from the central processing unit 1702 to each parallel processing unit module's memory 1324. In an embodiment, the NVLink 1320 supports coherency operations, allowing data read from the memory 1324 modules to be stored in the cache hierarchy of the central processing unit 1702, reducing cache access latency for the central processing unit 1702. In an embodiment, the NVLink 1320 includes support for Address Translation Services (ATS), enabling the parallel processing unit module to directly access page tables within the central processing unit 1702. One or more of the NVLink 1320 may also be configured to operate in a low-power mode.

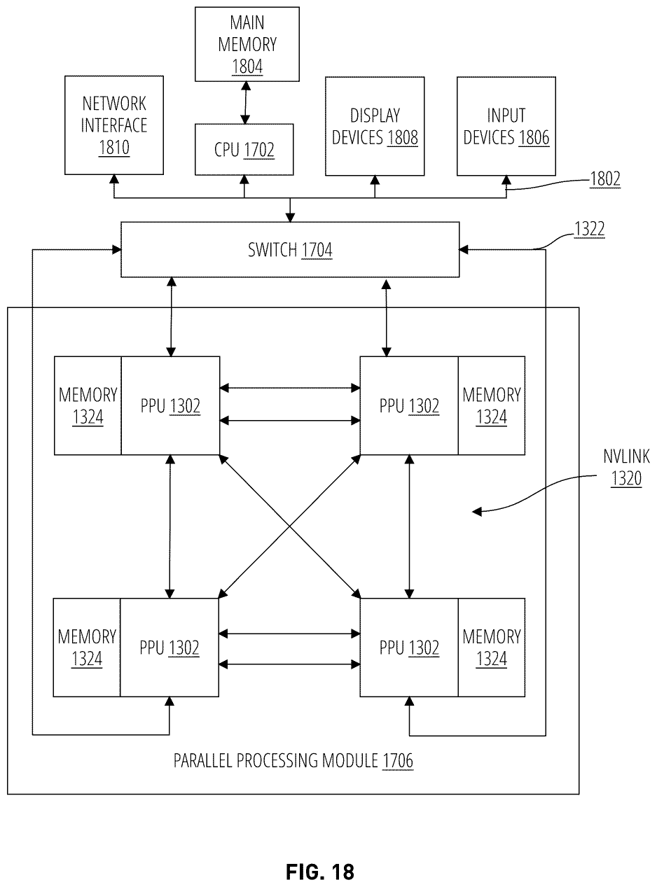

FIG. 18 depicts an exemplary processing system in which the various architecture and/or functionality of the various previous embodiments may be implemented. As shown, an exemplary processing system is provided including at least one central processing unit 1702 that is connected to a communications bus 1802. The communication communications bus 1802 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1804. Control logic (software) and data are stored in the main memory 1804 which may take the form of random access memory (RAM). For simplicity of illustration, the main memory 1804 may be understood to comprise other forms of bulk memory, including non-volatile memory technologies.

The exemplary processing system also includes input devices 1806, the parallel processing module 1706, and display devices 1808, e.g. a conventional CRT (cathode ray tube), LCD (liquid crystal display), LED (light emitting diode), plasma display or the like. User input may be received from the input devices 1806, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1810 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1804 and/or the secondary storage. Such computer programs, when executed, enable the exemplary processing system to perform various functions. The main memory 1804, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

402 interconnect
404a L2 cache slice
404b L2 cache slice
404c L2 cache slice
406a tracking logic
406b tracking logic
406c tracking logic
408a L1 cache slice
408b L1 cache slice
408c L1 cache slice
410a tracking logic
410b tracking logic
410c tracking logic
412a data processor core
412b data processor core
412c data processor core
414 request processor
416 memory FIFO
418 request FIFO
420 response FIFO
422 SRAM
424 memory FIFO
426 memory FIFO
428 core internal memory
430 SRAM
432 DMA interface
434 request FIFO
1202 shared memory
1302 parallel processing unit
1304 I/O unit
1306 front-end unit
1308 scheduler unit
1310 work distribution unit
1312 hub
1314 crossbar
1316 general processing cluster
1318 memory partition unit
1320 NVLink
1322 interconnect
1324 memory
1402 pipeline manager
1404 pre-raster operations unit
1406 raster engine
1408 work distribution crossbar
1410 memory management unit
1412 data processing cluster
1414 streaming multiprocessor
1416 primitive engine
1418 M-pipe controller
1502 level two cache
1504 raster operations unit
1506 memory interface
1602 shared memory/L1 cache
1604 instruction cache
1606 scheduler unit
1608 register file
1610 core
1612 special function unit
1614 load/store unit
1616 interconnect network
1618 dispatch
1702 central processing unit
1704 switch
1706 parallel processing module
1802 communications bus
1804 main memory
1806 input devices
1808 display devices
1810 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to”perform that function after programming.

Reciting in the appended claims that a structure is “configured to” perform one or more tasks is expressly intended not to invoke 35 U.S. C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A computer system comprising:
a shared memory system; and
logic configured to enable a consumer process to issue a request to establish a monitor in the shared memory system, whereby store operations by one or more producer processes to memory locations subscribed to in the request are one or both of counted and forwarded by the monitor to the consumer process.

2. The computer system of claim 1, wherein the consumer process is configured such that each time the one or more producer processes store data to the memory locations and the data is forwarded to the consumer process and the consumer increments a counter, and once the counter reaches a number of addresses in the memory locations, the consumer process signals the shared memory to release the subscription to the memory locations.

3. The computer system of claim 1, where the logic comprises a counter configured to track a number of the memory locations written by the one or more producer processes.

4. The computer system of claim 3, wherein the logic is configured to return a value of the counter to the consumer process along with an acknowledgement that a subscription to the memory locations has been established.

5. The computer system of claim 4, wherein the logic is configured to forward updates of the count to the consumer process as the one or more producer processes write to the subscribed memory locations.

6. The computer system of claim 5, wherein the consumer process is configured to read data from some or all of the subscribed memory locations once the count reaches a threshold value.

7. The computer system of claim 1, further comprising memory allocation logic configured to associate a tag with the memory locations upon their allocation.

8. The computer system of claim 7, wherein the request to establish the monitor comprises the tag.

9. The computer system of claim 7, wherein the logic is configured to update a count for the tag and forward a number of data values corresponding to the tag from the memory locations to the consumer process along with the tag.

10. The computer system of claim 1, wherein the request configures the monitor with an identifier of the memory locations to monitor for the store operations and with an address to the consumer process into which to update a count of the store operations.

11. The computer system of claim 1, the logic configured to establish the monitor in response to a store operation by the one or more producer processes on memory locations associated with a tag.

12. The computer system of claim 11, the logic configured to produce a count of the store operations by the one or more producer processes and to delay forwarding the count to the consumer process for a configured interval of time.

13. The computer system of claim 1, wherein:
the one or more producer processes are configured subscribe to a flag in the shared memory indicating that the memory locations may be overwritten;
the one or more producer processes are configured to store values to the memory locations until the memory locations are full;
the consumer process is configured to produce a count of the stored values that are forwarded to the consumer process and to set the flag when the consumer process receives stored values from all of the memory locations; and
the logic is configured to forward the flag to the one or more producer processes in response to the consumer process setting the flag.

14. The computer system of claim 1, the logic configured to notify the one or more producer processes of the request to establish the monitor from the consumer process.

15. The computer system of claim 1, the logic configured to produce a count of a number of consumptions by the consumer process of data written by the store operations.

16. The computer system of claim 15, wherein the one or more producer processes are configured to allocate memory to receive the count and to submit a request to monitor the count.

17. A process comprising:
allocating a ring buffer comprising a plurality of segments in a shared memory;
allocating flags in the shared memory for each of the segments with a producer process;
allocating a global flag in the shared memory;
issuing an LDSUB. GET for a head segment of the ring buffer with a consumer process;
issuing an LDSUB. GET for the global flag with the producer process; and
setting the global flag with the consumer process in response to the consumer process consuming data from one or more of the segments.

18. The process of claim 17, further comprising:
issuing LDSUB. COUNT operations for each of the segments with the consumer process.

19. A non-transitory machine-readable media comprising instructions that, when applied to one or more data processor, configure a computer system comprising the one or more data processor to:
issue a request from a consumer process to establish a monitor in a shared memory;
count store operations to a range of memory locations by one or more producer processes; and
forward values in the memory locations set by the store operations to the consumer process.

20. A non-transitory machine-readable media further comprising instructions that, when applied to the one or more data processor, configure the computer system to:
increment a counter each time the one or more producer processes store values in the memory locations; and
once the counter reaches a number of addresses in the memory locations, signal the shared memory to release the monitor of the memory locations.
